(19) United States
(12) Patent Application Publication
(10) Pub. No.: US 2025/0137402 A1
(43) Pub. Date: May 1, 2025

(54) Turbine driven by confrontation of explosions of oxygen and hydrogen, or any hydrogenated hydrocarbon, under pressure and vacuum by aqueous precipitation of the resulting water vapor

(71) Applicant: Sebastián Enrique BENDITO VALLORI, Inca (ES)

(72) Inventor: Sebastián Enrique BENDITO VALLORI, Inca (ES)

(21) Appl. No.: 18/832,552

(22) PCT Filed: Nov. 8, 2022
(86) PCT No.: PCT/ES2022/070714

§ 371 Date: Jul. 24, 2024

(30) Foreign Application Priority Data
Mar. 23, 2022 (ES) P202230254

(51) Int. Cl. F02C 3/22; F01D 1/34; F02C 7/232

(52) U.S. Cl. CPC F02C 3/22; F01D 1/34; F02C 5/12; F02C 7/232; F02C 9/50

(57) ABSTRACT

Engine consisting of a turbine driven by confrontation of explosions and vacuum on both sides of its blades; deflagrations caused by the reaction of oxygen and hydrogen under pressure, or any hydrogenated hydrocarbon and the first mentioned gas, and the shrinkage derived from the precipitation of water vapor obtained from said combinations by means of the aqueous spraying thereof with liquid water.

Engine that is capable of obtaining its rotary power from the use of a succession of explosions, either by injection of hydrocarbon fluidhydrogenated well of pure hydrogen under pressure, in combination with oxygen at equal stake executed on one of the faces of a turbine and obtaining a depression, in front of the other face of said rotating element, by precipitation of the water vapor resulting from the previous chemical reaction, through the spraying it with liquid water; method, which constitutes an evolution of part of the mechanism of the hydraulic transmission system with developments by electromagnetic control for vehicles, with generation and propulsion discretionary electrical, under application number P202130350, so both they partially coincide in their constitutive structure, as will be seen.

The device proposed here is a high-performance turbine with great reduction of carbon emissions into the atmosphere, in case of burning a fluid hydrocarbon, or completely eliminate such residues if you do it with hydrogen pure; Furthermore, by never consuming atmospheric air, the production of polluting residues derived from the nitrogen that is part of said mixture gas, which means obtaining an optimal motor source capable of relieving the nature of much or all of the harm that our mobility brings.

According to previous research carried out, the device currently does not exist here vindicated, so I request that you grant me the rights corresponding to the mill described below in a practical case of industrial application, which is reinforced in its understanding with a series of schematic figures that represent it; In all of them, the lines drawn line followed by a dot indicate the hollowness of the space on which they are drawn and those that have a discontinuous line that the part thus reflected is hidden in that view.

For explanatory purposes, the device collected here is made up of three elements, communicated online through separate channels whose links respective sealing with the outside:

One injector, which we call that.

Another, called rotor, which is basically the same as those claimed as driving device and wheel in the patent cited above, as will be seen throughout the explanation.

A vacuum cleaner, known this way.

In addition, it has an electrical circuit; which, like said patent, also integrates a battery that now powers a series of pressure gauges, another of levels aqueous and a revolution counter from whose data it controls a series of solenoid valves and a spark plug, as will be explained.

FIG. 1 shows the profile of a rigid, compact and pressure-temperature resistant element, which is designated with the number 30; we know it as a driver and in it (30) they open:

Under anagram 31, a pressurized oxygen tank which (31) has made a spherical opening reflected with the number 34.

The oxygen tank (31) communicates with the outside, for eventual recharging through a cylindrical conduit that has a spherical cavity in its part half; We call this step oxygen loading and it is detailed with the number 39.

Marked as 32, there is a tank that we call fuel that contains hydrogen at its discretion at the same pressure as the oxygen already detailed or hydrocarbon fluid with hydrogen injected at the same intensity.

The fuel tank (32) communicates with the outside, for its eventual recharge, through a cylindrical conduit that has a spherical cavity in its middle part; We call this step fuel loading and it is detailed with the number 40.

Said tank (32) has a spherical opening reflected with the number 35.

The spherical opening of the oxygen tank (34), and that of the oxygen tank fuel (35), communicate with the chamber that we call the mixture, which is sample under anagram 33.

The number 37 indicates the combustion chamber of the material coming from mixing chamber (33); the external walls of the combustion chamber (37).

They are suitable for radiating a large amount of heat to the surrounding medium.

The combustion chamber (37) has a cylindrical cavity marked with the number 36 and another detailed hexagonal with 40.

FIG. 2 shows the top view of the diametrically horizontal section of a container, which is similar in its geometric constitution to those of the hydraulic transmission system mentioned above, which we generically call case; It includes, with the anagram 0, a rigid cylindrical container, dense and resistant to elevated temperature and pressure; its geometry characterized by having:
Three equal protuberances, of which only two hidden views appear here, fifteen passed through separate threaded cylindrical holes generically called hitch, under the respective designation 4 and 5.
A coaxial hole that passes through its center to the cylindrical body of the same (0), marked with the number 6 which we will generically call the route of casing.
A cylindrical concavity, generally called a sinus, opens in one of the casing bases, which is shown with notation 9.
A cylindrical conduit that has an open spherical opening, represented under the sign 1 and which we call generically in passing, communicates in a biased way to the sinus (9) with the base opposite to it of the casing (0), hence its hidden representation.
A cylindrical conduit, represented under the sign 2, which we call generically counter, communicates perpendicularly to the sine (9) with the base opposite the same of the casing (0).

The following semitoroidal ducts are reflected, open to different diameters on the circular surface of the sine (9):
With the anagrams 71 and 71′, the upper and lower slopes respectively of the channel that we generally know as a major static joint.
With the anagrams 72 and 72′, the upper and lower slopes respectively of the channel generically called a minor static joint.
A semitoroidal channel, which we will generally call a bearing, is indicated respectively with the symbols 8 and 8′ in their lower and lower openings upper part of the lateral wall of the sinus (9) in which it is inserted.

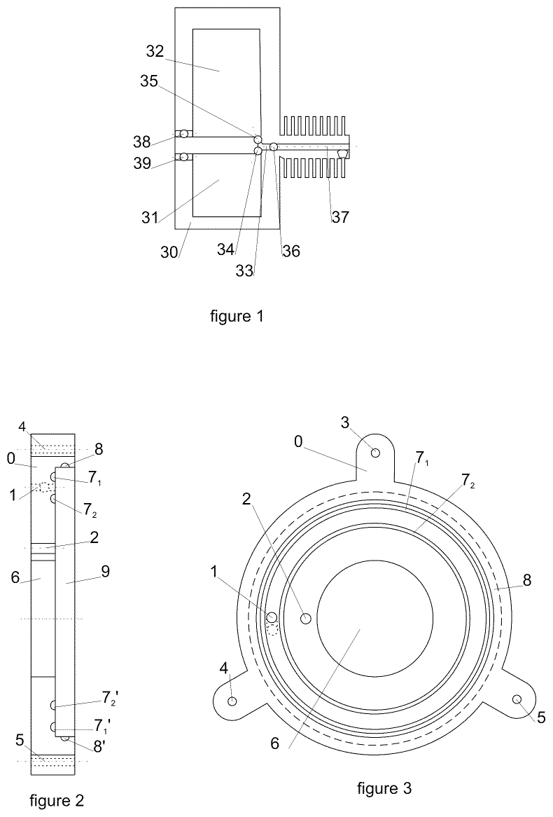

FIG. 3 is the elevation drawing of a casing seen from the right side of the previous representation, of which it repeats the terminology, adding a upper protuberance, equal to the previous ones and also crossed by a new hitch, now with designation 3.

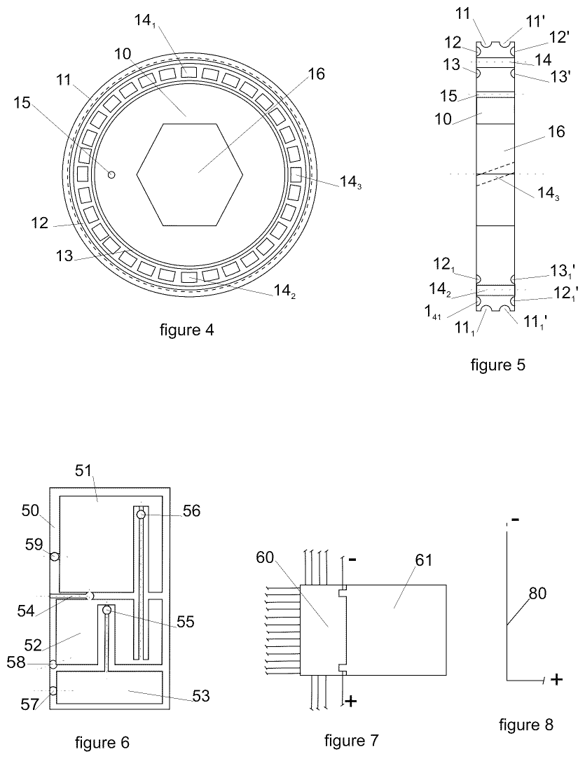

FIG. 4 shows the elevation view of a compact rigid cylindrical piece, resistant to high temperature and pressure detailed with the number 10, to which we will call it the driving rotor.

The same (10) is identical to its analogue in the transmission system patent, unlike the fact that here it only has one turbine with its two channels of insulation and not three with their respective means of sealing as it does in that patent.

We can see, hidden in this view and with the number 11, a semitoroidal groove practiced on the side of the drive rotor (10) we call it in a generic way twenty drive bearing.

The bases seen here of the drive rotor (10) open two semitoroidal concavities to which we will designate and know generically as:
With the anagram 12, the major drive joint channel.
With the anagram 13, the minor drive joint channel.

The dimensions of both (12 and 13) coincide respectively with those of the major (71) and minor (72) static joint channels.

A central hexagonal channel, which we will call the reflected power intake with the number 16, orthogonally communicates coaxially both bases of the rotor motor (10).

The drive rotor (10) is transferred from base to base obliquely by a series concentric of holes, whose separating blades we will know as a turbine engine; of which we can see its upper openings identified with the anagram 141, lower with the FIG. 142 and the right quadrangular with the 143.

A cylindrical hole that communicates perpendicularly the two bases of the drive rotor (10), which we call the motor counter, is indicated with the sign 15.

FIG. 5 is the profile of the driving rotor in which the designations of the previous figure more particularizing here as follows:
The sign 11 designates what we know as the drive bearing channel injection.
The 11′ is made with what is known as the suction motor bearing channel.
With the anagrams 12 and 121, the upper and lower slopes of the major injection drive joint channel.
With the anagrams 13 and 131 the upper and lower slopes of the joint channel minor injection motor.
With the anagrams 12′ and 121′ the upper and lower slopes are respectively seen.

### Bottom of the Main Suction Drive Seal Channel.

With the anagrams 13′ and 131′ the upper and lower slopes are respectively seen.

### Bottom of the Minor Suction Drive Joint Channel.

FIG. 6 shows the profile of a rigid, compact and resistance to corrosion pressure and temperature element indicated with the number 50; We know it as a vacuum cleaner.

And in it (50) they open:
ÿ Under logo 51, a vacuum tank.
ÿ Designated as 52, a liquid water tank, which always contains certain amount of said element.
ÿ The number 53 indicates the exhaust tank.
ÿ FIG. 57 details the spherical hole that communicates to the exhaust tank (53) with the exterior which we call the remnant duct.
ÿ The spherical hole that constitutes the suction conduit is designated with the number 59 and opens to the vacuum tank (51) to the outside.
ÿ The vacuum tank (51) and the liquid water tank (52) communicate each other through the spherical opening, which we know as the purge outlet, noted as 54; which (54) also opens to the outside through a hole cylindrical.
ÿ In a cylinder, which is an integral part of the suction body (50) and ascends inside the liquid water tank (52), a conduit of the same geometry opens which has an open spherical opening near its upper end; channel, which communicates the latter (52) with the exhaust tank (53) and which we call pressure connection designated with the number 55.
ÿ Called spray duct and with designation 56, a channel appears cylindrical that has an open spherical opening near its upper end; he The same (56) is made to a cylinder that, being an integral part of the body aspirator (50), rises inside the vacuum tank (51) and descends inside the of liquid water (52) communicating both (51 and 52).
ÿ under logo 58 we see the spherical drain pipe, which opens to the tank of liquid water (52) to the outside.

FIG. 7 represents the partial profile view of the electrical circuit installed in the present system since the figure only shows, with designation 61, a battery electric represented with the signs + and − and, under number 60, a digital control electronic which we call control; This one (60) is connected to this one (61) and all the electrical components that make up the system through separate circuits that are sectioned here and will be detailed below.

FIG. 8 shows the profile of a section of the electrical ignition circuit, when which we call spark plug, is reflected as 80.

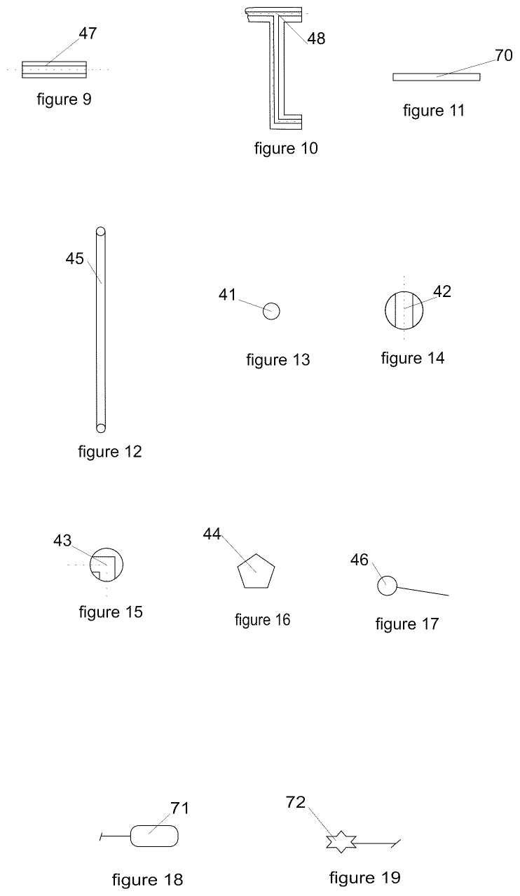

FIG. 9 shows the longitudinal section of a dense conduit, resistant to pressure and temperature, capable of radiating this towards the surrounding medium and that It can be either rigid or flexible at your discretion, which we call a low injector with designation 47.

FIG. 10 shows the longitudinal section of a dense, tee-shaped duct resistant to pressure and temperature that can be either rigid or flexible, which we call exhaust under designation 48.

FIG. 11 describes a screw that, here under sign 70, will be known as tie.

FIG. 12 is the diametral cut of an O-ring generally designated with the logo 45 as there will be different diameters as will be detailed.

FIG. 13 represents the side view of a rigid and polished sphere in its surface, of equal diameter to all the bearing grooves present in the invention, which under the name bearing is designated with the number 41.

FIG. 14 shows with sign 42 the diametral cut of a rigid and polished sphere on its surface, opened diametrically by a straight cylindrical conduit of a certain radio; It is a rotary closure solenoid valve that we will know in general as management.

FIG. 15 specifies with sign 43 the diametral cut of a rigid and polished sphere on its surface; his body is diametrically opened by a duct square cylindrical of a certain radius; It is a rotary closing solenoid valve which we will generally know as purge management.

FIG. 16 represents, with the number 44, the profile of a manometer.

FIG. 17, with the sign 46, shows the profile of an electronic level that It incorporates a float attached to a rod.

A photoelectric sensor is drawn in FIG. 18 under symbol 71; the same (71) is connected to the electrical circuit, here present in a section, which joins it to the control (60).

In FIG. 19 a light appears, which we call under designation 72; the itself (72) is connected to the electrical circuit, here present in a section, that unites him to control (60).

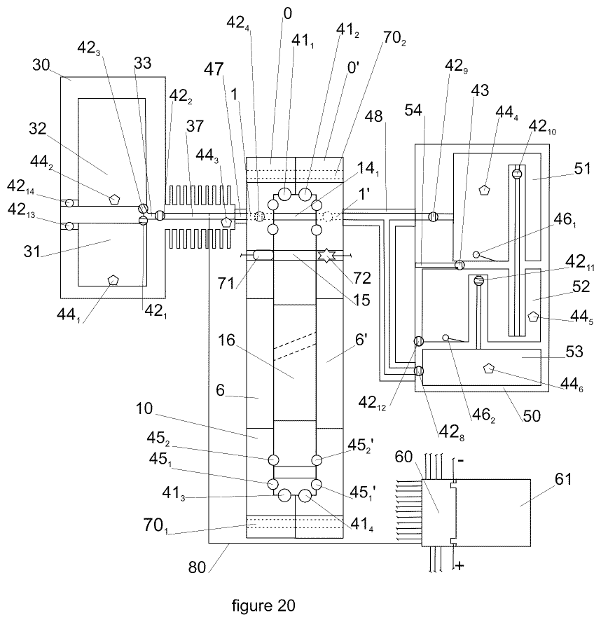

FIG. 20 shows the assembly of all detailed system components Until now.

Thus, two casings, which we particularize respectively in their denomination as injection, with designation 0, and suction with sign 0′, They are seen coupled one (0) to the other (0′) by means of the threading in the respective attachments of respective ties, under respective designation (711 and 712), here visible in hidden.

The injection passage, carried out in the injection casing (0), has the designation 1; while, 1′, shows us the suction open in the suction (0′).

The respective sinuses (9) of both casings (0 and 0′) contain the drive rotor (10), of which its power intake (16) is detailed, a turbine bay itself motor 141 and the motor counter (15).

The symbols seen so far are repeated, with the exception that the different repeated parts in the same, that is: bearings, pressure gauges, electro-valves, levels, o-rings and lines are scored by the addition of a number in subscript, and quotation mark if applicable, as follows:
411 and 413 represent separate spheres that make up the filling series of bearings located in the injection drive bearing channel (11).
412 and 414 represent separate spheres that are part of the filling series of bearings located in the evacuation drive bearing channel (11′).
441 represents the pressure gauge of the oxygen tank (31).
442 points to the fuel tank pressure gauge (32).
443 indicates the pressure gauge located in the combustion chamber (37).
444 represents the vacuum manometer (51).
445 points to the pressure gauge of the liquid water tank (52).
446 indicates the exhaust pressure gauge (53).
461 represents the level of the vacuum tank (51).
462 points to the level of the liquid water tank (52).
421 represents the solenoid valve installed in the upper duct (35) to which we call it oxygen management.
422 indicates the solenoid valve installed in the spherical opening of the lower duct (36) which we call fuel management.
423 indicates the solenoid valve installed in the spherical opening of the conduit intermediate (37) and we call it intermediate management.
424 represents the solenoid valve installed in the injection duct (38) being called injection management.
428 indicates the solenoid valve installed in the spherical opening of the remainder (57) which we know as remainder management.
429 indicates the solenoid valve installed in the spherical opening of the suction (59) called suction management solenoid valve.
4210 represents the solenoid valve installed in the spherical opening of the spray (56) called spray management.
4211 indicates the solenoid valve installed in the spherical opening of the impulse (55) known as impulse management.
4212 presents the solenoid valve installed in the spherical opening of the drainage (58) known as drainage management.
4213 indicates the solenoid valve installed in the oxygen loading step (39) known as oxygen charging solenoid valve.
4214 indicates the solenoid valve installed in the fuel charging passage (40) Known as the fuel charging solenoid valve.
451 indicates the lower slope of the larger injection joint.
452 indicates the smaller injection joint on the lower side.
451′ indicates the lower slope of the major suction joint.
452′ indicates the lower slope of the smaller suction joint.

The sign 43 indicates the solenoid valve, called purge, installed in the duct purge (54).

The battery (61) maintains electrical communication with the control (60), which shows a series of sections of electrical circuits emerging from it (60), which connect, each one of them in particular with a solenoid valve (42n), level (46n), pressure gauge ((44n) or spark plug (80) either receiving information from them, or managing your action.

In the figure we can see the watertight connection of the impeller (30) with the duct injector (47) that joins it sealed to the injection housing (0) of the driving element.

Next, the drive rotor (10) is arranged, which is channeled in the sine (9) of this (0) by means of a series of bearings (411-413).

A second series of bearings (412-414) guide the drive rotor (10) in the sinus of the suction casing (0′).

In the confrontation of the injection casing (0) and drive rotor (10) the following are faced:
The larger injection static seal channel (71) with the drive seal channel larger injection joint (12), in whose opening the larger injection joint is inserted (451).
The minor injection static seal channel (72) with the drive seal channel smaller injection seal (13), in whose opening the injection seal is inserted major (452).

When the suction casing (0′) and drive rotor (10) confront each other:
The larger suction static seal channel (71′) with the drive seal channel of greater suction (12′), in whose opening the greater suction joint (451′) is inserted.
The smaller suction static seal channel (72′) with the drive seal channel minor suction (13′), in whose opening the minor suction joint (452′) is inserted.

This illustration also describes the watertight connection of the housing suction (0′) to the exhaust duct (48), which (48) communicates doubly with the vacuum cleaner (50) maintaining tightness in its links.

Thus the system works as follows:

First, the oxygen (31) and fuel (32) tanks are filled by connection to their respective oxygen loading steps (39) and fuel (40) from each supply source, which are filled at the load pressure maximum, under direction of the control (60) that carries out the opening and closing of the respective oxygen supply electro valves (4213) and fuel (4214), in order to achieve this objective.

After that, at the command of the system user on the control (60), it (60) starts two repetitive procedures for the duration of the aforementioned mandate:
a) The explosion of the fuel, operated by injection into the combustion chamber (34) from the oxygen tank (31) of such gas and from that of fuel (32), given the already mentioned nutritional discretion of a optional amount of fuel; supplies that occur through opening of the oxygen management solenoid valves (421) and fuel (422), after 30 that the control (60) closes both (421) and (422) once the desired quantities.

The precision of said gaseous supplies is determined thanks to the analysis in the control (60) of the variation of pressures existing in the oxygen tank (31) and the fuel (32) recorded by their respective pressure gauges (441) and (442).

Next, the control (60) sends an electrical pulse to the spark plug (80) that ignites the aforementioned gas mixture; which produces, in case of explosion hydrogen, pure water vapor and, if hydrogenated hydrocarbon, also said steam with a minor addition of carbon monoxide and carbon dioxide.

After this, the control (60) opens the intermediate management solenoid valve (423) so that the product of the previous reaction flows into the expansion chamber (33), where the manometer (443) of said chamber (33) communicates to the control (60) the pressure rise reached, with which it (60) closes the solenoid valve intermediate management (423) once the density of the gas housed in the chamber combustion chamber (34) has dropped to the appropriate level for its re-gaseous feeding by repetition of the supply cycle detailed above, with which the driving part of the engine is started, which in the present occupies the repetition of explosions like the one mentioned increases the pressure in the expansion chamber (33), which registers the control (60) and reverts such information to the driver of the vehicle carrying the device described here.

At the will of said recipient of information, and by his order conferred on the control (60), the injection management solenoid valve (424) opens during the time required engine performance, to a greater or lesser extent, depending on claimed more or less power, passing the product of the explosions to through the injection duct (47), from which it impacts with the blade of the 25 the motor turbine (28) that is located in its path, so it exerts its pressure on the contact surface between the two, creating a depression in the opposite face of said vane, which gives powerful rotation to the drive rotor (20), thereafter dividing the water vapor its path into the duct suction (48) towards the vacuum tank (51) and the exhaust tank (53); traffic what is regulated by the control based on the values offered by the pressure gauges vacuum (444) and exhaust (446) operating the suction management solenoid valves (429) and remainder (428).
b) The precipitation of water vapor already located in the vacuum tank (53), with the dragging of the other gases present there in solution, it produces by nebula injection of liquid water from its tank (52) in the interior of that (53); action that occurs through controlled opening (60) of the spray management electro-valve (4210), after having increased the pressure in the liquid water tank (52) by inserting steam into it (52) coming from the exhaust tank (53), which occurs by opening punctually of the drive management solenoid valve (4211) by the control (60).

Once the water has been poured into the vacuum tank (53), it is deposited inside the purge valve (43), which is, as shown in FIG. 20, making room for the arriving water, due to the absence of communication of this liquid with any space colt, the level of the vacuum tank (461) communicates to the control (60) the overflow of the capacity of said valve (43), and this (60) is responsible for transferring that liquid to the liquid water tank (52) by ordering that (43) its hourly rotation of 270 degrees, with which the water falls into the tank of liquid water (52) by acquiring atmospheric air from its other end, now open to the outside through the purge line (54) after which valve The purge valve (43) returns to its original position by order of the control (60).

The level of the liquid water tank (462) indicates the amount of water it occupies said container (52), data that is communicated to the control (60) for the purpose of emptying it exceed a certain volume, which will be executed by opening the management drain valve (4212) towards the outside to close it after the level drops aqueous up to the amount desired by the driver.

Procedures that are repeated whenever there is an order for engine action in the control (60), for which purpose the drive rotor (20) rotates along the gradient depression existing on both sides of its engine turbine (28), giving up its power to either a wheel, propeller or combination of the two. The oxygen (31) and fuel (32) tanks can be at discretion refueled by repeating the procedure already detailed.

It is not considered necessary to make this description more extensive so that Any person skilled in the art understands the scope of the invention and the advantages that derive from it.

The terms in which this report has been written must be taken 5 always in a broad and non-limiting sense.

The materials, shape and arrangement of the elements will be susceptible to variation, as long as this does not imply an alteration of the characteristics essentials of the invention presented here according to the following

1. A turbine driven by confrontation of explosions of oxygen and hydrogen or any hydrogenated hydrocarbon under pressure and vacuum by aqueous precipitation of the resulting water vapor comprising the following components:
An electric battery (61).
An electronic control (60).
A spark plug (80).
An impeller (30) consisting of:
An oxygen tank (31).
The oxygen charging solenoid valve (42₁₃).
A fuel tank (32).
The fuel charging solenoid valve (42₁₄).
A mixing chamber (33).
A combustion chamber (37) with high cooling capacity.
The oxygen management solenoid valve (42₁).
The fuel management solenoid valve (42₂).
The intermediate management solenoid valve (42₃).
An oxygen tank pressure gauge (44₁).
A fuel tank pressure gauge (44₂).
A combustion chamber pressure gauge (44₃).
An injector line (47).
An injection housing (0), in which the injection management solenoid valve (42₄) is installed.
A suction housing (0′).
A driving rotor (10), on the side of which the injection (11 and 11₁) and suction (11′ and 11_{1′}) driving bearing channels open.
Communicating coaxially its bases it is crossed by a power intake (16).
Skewed to said bases, there is a concentric series of spans (14₁, 14₂ and 14₃) whose separating blades constitute the motor turbine therein.
On one of the bases of the driving rotor (10) are arranged the channels of the major injection driving seal (12 and 121) and the minor injection driving seal (13 and 131); on the other, those of the major suction driving seal (12′ and 12₁′) and the minor suction driving seal (13′ and 13_{1′}).
The driving rotor (10) has on its side the injection driving bearing channel (11) and the suction driving bearing channel (11′).
The required number of bearings (41₁, 41₂, 41₃ and 41₄) to fill the injection drive bearing race (11) and suction drive bearing race (11′).
A major injection seal (452). A minor injection seal (451). A major suction seal (45₁′).
A minor suction joint (45₂′).
An exhaust duct (48).
A vacuum cleaner (50) comprising:
A vacuum reservoir (51).
A liquid water reservoir (52).
n exhaust tank (53).
A backwater management solenoid valve (42₈).
A suction management solenoid valve (42₉).
A spray management solenoid valve (42₁₀).
A drive management solenoid valve (42₁₁).
A drain management solenoid valve (42₁₂).
A bleed management solenoid valve (43).
A vacuum pressure gauge (44₄).
A liquid water tank pressure gauge (44₅).
An exhaust pressure gauge (446). A vacuum reservoir level (46₁).
A liquid water reservoir level (46₂).
